(19) United States
(12) Patent Application Publication
(10) Pub. No.: US 2025/0201874 A1
(43) Pub. Date: Jun. 19, 2025

(54) APPARATUS AND METHOD FOR CONTROLLING WATER EMISSION OF A VEHICLE

(71) Applicants: HYUNDAI MOTOR COMPANY, Seoul (KR); KIA CORPORATION, Seoul (KR)

(72) Inventors: Jun Young Kim, Goyang-si (KR); Kyu Beom Kim, Suwon-si (KR); Byoung Sun Park, Seoul (KR); Jung Seok Suh, Yongin-si (KR); Mi Jin Chung, Seoul (KR)

(73) Assignees: HYUNDAI MOTOR COMPANY, Seoul (KR); KIA CORPORATION, Seoul (KR)

(21) Appl. No.: 18/811,502

(22) Filed: Aug. 21, 2024

(30) Foreign Application Priority Data
Dec. 13, 2023 (KR) 10-2023-0180790

(51) Int. Cl. H01M 8/04119; B60L 58/30

(52) U.S. Cl. CPC H01M 8/04156; B60L 58/30; H01M 2250/20

(57) ABSTRACT

An apparatus for controlling water emission of a vehicle includes: a water amount determination part configured to determine an amount of water held in the vehicle through a sensor; a surrounding situation recognition part configured to recognize nearby vehicles including a trailing vehicle driving within a predetermined distance behind the vehicle; and a vehicle controller configured to control at least one of an emission time or an emission amount of the water, depending on the amount of water and a presence or absence of the nearby vehicles.

### CROSS-REFERENCE TO RELATED APPLICATIONS

This application claims priority to Korean Patent Application Number 10-2023-0180790, filed on Dec. 13, 2023, which application is hereby incorporated herein by reference.

### TECHNICAL FIELD

The present disclosure relates to an apparatus and method for controlling water emission of a vehicle.

### BACKGROUND

The content described below simply provides background information related to the present disclosure and may not constitute related art.

The related art hydrogen fuel cell vehicle technology automatically emits drain water as vehicles drive. Drain water refers to condensation water generated when air is compressed. How to utilize the drain water is a major concern. However, there is no solution to cases where drain water is stored in too large an amount and should be emitted. When the drain water is emitted, although it is pure water, the drain water may freeze immediately in winter and form black ice on the road surface. Also, if a large amount of drain water is emitted and vehicles are close together, contamination may occur in a following vehicle.

### SUMMARY

In view of the above, the present disclosure provides an apparatus and method for preventing contamination of a following or trailing vehicle due to water emission.

The present disclosure provides an apparatus and method for providing a human machine interface (HMI) to nearby vehicles to reduce contamination of a following vehicle due to water emission.

The problems to be solved by the present disclosure are not limited to the problems mentioned above, and other problems not mentioned should be more clearly understood by those having ordinary skill in the art from the description below.

According to an embodiment of the present disclosure, an apparatus for controlling water emission of a vehicle includes a water amount determination part configured to determine an amount of water held in the vehicle through a sensor. The apparatus also includes a surrounding situation recognition part configured to recognize nearby vehicles including a following or trailing vehicle driving within a predetermined distance behind the vehicle. The apparatus also includes a vehicle controller configured to control at least one of an emission time or an emission amount of the water, depending on the amount of water and a presence or absence of the nearby vehicles.

According to an embodiment of the present disclosure, a method for controlling water emission of a vehicle includes determining, by a water amount determination part, an amount of water held in the vehicle through a sensor. The method also includes recognizing, by a surrounding situation recognition part, nearby vehicles including a following or trailing vehicle driving within a predetermined distance behind the vehicle. The method also includes controlling, by a vehicle controller, at least one of an emission time or an emission amount of the water, depending on the amount of water and a presence or absence of the nearby vehicles.

The present disclosure may prevent contamination of a following vehicle due to water emission.

The present disclosure may reduce contamination damage to a following vehicle due to water emission by providing a human machine interface (HMI) to nearby vehicles.

The effects of the present disclosure are not limited to the effects mentioned above. Other effects not mentioned herein may be more clearly understood by those having ordinary skill in the art from the description below.

### BRIEF DESCRIPTION OF THE DRAWINGS

FIG. 1 is a block diagram of an apparatus for controlling water emission of a vehicle according to an embodiment of the present disclosure.

FIG. 2 is a flowchart illustrating a method for controlling water emission of a vehicle according to an embodiment of the present disclosure.

FIGS. 3-7 are various diagrams illustrating a method of controlling water emission of a vehicle according to an embodiment of the present disclosure.

The drawings described herein are for illustration purposes only and are not intended to limit the scope of the present disclosure in any way.

### DETAILED DESCRIPTION

Hereinbelow, some embodiments of the present disclosure are described in detail with reference to the accompanying drawings. In the following description, like reference numerals may designate like elements, even though the elements may be shown in different drawings. Further, the following description of some embodiments may omit, for the purpose of clarity and for brevity, a detailed description of related known components and functions where considered to have obscured the subject of the present disclosure.

Various ordinal numbers or alpha codes such as “first”, “second”, “A”, “B”, “(a)”, “(b)”, and the like, may be prefixed solely to differentiate one component from another but not to necessarily imply or suggest the substances, order, or sequence of the components. Throughout this specification, when a part “includes” or “comprises” a component, the part is meant to allow for further including other components and to not exclude other components, unless specifically stated to the contrary. Terms such as “unit,” “module,” “part”, and the like may refer to units in which at least one function or operation is processed and may be implemented by hardware, software, or a combination thereof. When a component, part, module, controller, device, element, apparatus, or the like of the present disclosure is described as having a purpose or performing an operation, function, or the like, the component, part, module, device, element, apparatus, or the like should be considered herein as being “configured to” meet that purpose or to perform that operation or function. Each component, part, module, controller, device, element, apparatus, and the like may separately embody or be included with a processor and a memory, such as a non-transitory computer readable media, as part of the apparatus.

In this specification, drain water refers to condensation water generated when air is compressed, but may be expressed as “water” and is not limited thereto.

A vehicle according to an embodiment of the present disclosure refers to a fuel cell vehicle performing fuel cell electric vehicle (FCEV) autonomous driving but is not limited to a specific type.

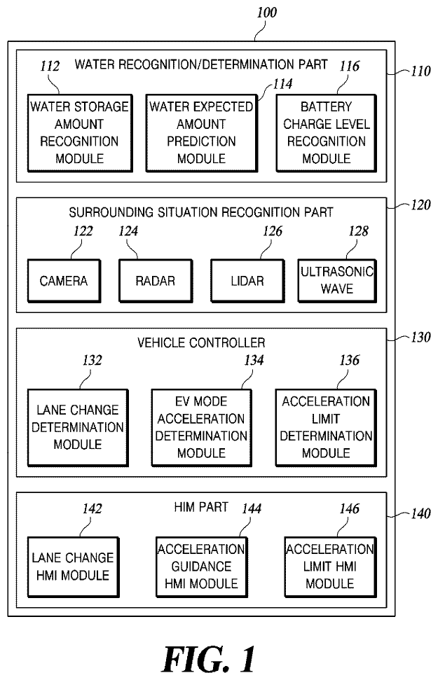

FIG. 1 is a block diagram of an apparatus for controlling water emission of a vehicle according to an embodiment of the present disclosure.

The apparatus for controlling water emission of a vehicle according to an embodiment of the present disclosure may include a water recognition/determination part 110, a surrounding situation recognition part 120, a vehicle controller 130, a human machine interface (HMI) 140, and/or the like.

The water recognition/determination part 110 includes a water storage amount recognition module 112, a water expected amount prediction module 114, and a battery charge level recognition module 116. The battery charge level recognition module 116 may be included in the water recognition/determination part 110 or may be included as a separate component.

The water storage amount recognition module 112 recognizes a current water storage amount status through a vehicle sensor. The vehicle sensor is not limited to a specific type.

The water expected amount prediction module 114 predicts an additional water storage amount according to acceleration through the vehicle sensor. The vehicle sensor is not limited to a specific type.

The battery charge level recognition module 116 recognizes and determines a battery charge level of the vehicle. The battery charge level of the vehicle may be determined through a state of charge (SOC).

The surrounding situation recognition part 120 recognizes and determines vehicle operation within a certain distance using a camera 122, a radar 124, a lidar 126, an ultrasonic wave 128, and/or the like. The surrounding situation recognition part 120 recognizes and determines a vehicle operation within a certain distance using equipment that may recognize a vehicle in addition to the camera 122, the radar 124, the lidar 126, and the ultrasonic wave 128.

If the amount of water (current water storage amount or the sum of the current water storage amount and additional water storage amount) is equal to or greater than a predetermined amount, the vehicle controller 130 controls the vehicle to reduce contamination of a rear vehicle before emitting water, and control water emission. The vehicle controller 130 includes a lane change determination module 132, an electric vehicle (EV) mode acceleration determination module 134, an acceleration limit determination module 134, and/or the like.

The lane change determination module 132 controls lane change when there are no vehicles in an adjacent lane and there is no problem with emitting water.

The EV mode acceleration determination module 134 accelerates forwardly using only EV mode (HVBattery) to increase a distance from the rear vehicle, i.e., another vehicle that is following, trailing, or behind the vehicle, when it is possible to secure the distance from the rear vehicle by accelerating forwardly. The EV mode represents a pure electric vehicle mode that uses only power of a driving motor. The EV mode may be referred to as an acceleration mode.

HVBattery represents a main battery of an electric vehicle.

The acceleration limit determination module 134 limits a function of excessively generating water when it is impossible to change lanes or increase the distance from the rear vehicle.

The HMI part 140 displays guidance for water emission and guidance related to vehicle control. This HMI part 140 includes a lane change HMI module 142, an acceleration guidance HMI module 144, an acceleration limit HMI module 146, and/or the like. The HMI part 140 may be referred to as a display and may perform a function of visually and audibly outputting information or status of the vehicle to a driver and occupants other than the driver through a number of physical interfaces. The HMI part 140 may perform a function of controlling autonomous driving of the vehicle. The HMI part 140 may receive a user input or output information or status of the vehicle in order to perform embodiments of the present disclosure.

The lane change HMI module 142 guides acceleration and water emission after changing lanes for smooth water emission.

The acceleration guidance HMI module 144 guides Only EV mode acceleration and water emission for smooth water emission.

The acceleration limit HMI module 146 provides additional acceleration limits to prevent damage (contamination) to a rear vehicle.

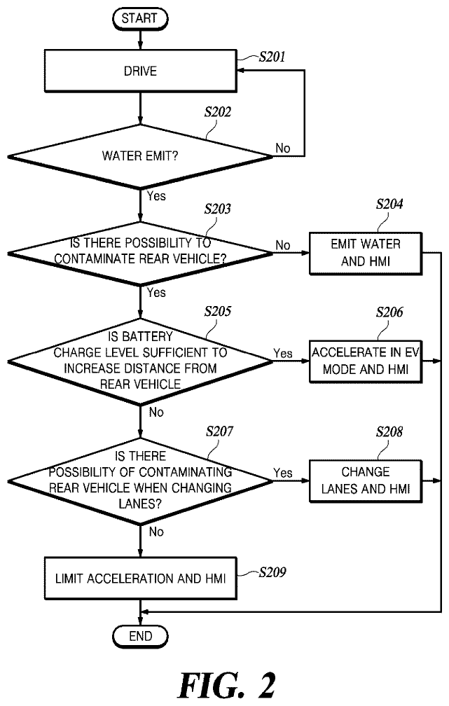

FIG. 2 is a flowchart illustrating a method for controlling water emission of a vehicle according to an embodiment of the present disclosure.

The apparatus for controlling water emission of a vehicle according to an embodiment of the present disclosure recognizes that the vehicle is driving in operation S201.

The apparatus for controlling water emission of a vehicle determines whether to emit water in operation S202.

If water is not emitted, the apparatus for controlling water emission of a vehicle proceeds to operation S201.

However, when water is emitted, the apparatus for controlling water emission of a vehicle determines whether there is a possibility of contamination of the rear vehicle within a certain distance in operation S203.

If there is no possibility of contamination of the rear vehicle within a certain distance, the apparatus for controlling water emission of a vehicle emits water and guides water emission using the HMI in operation S204. In addition, the apparatus for controlling water emission of a vehicle may inform that there is no possibility of rear vehicle contamination using the HMI.

If there is a possibility of contamination of the rear vehicle within a certain distance, the apparatus for controlling water emission of a vehicle determines whether a battery charge level is sufficient to increase the distance from the rear vehicle in operation S205.

If the battery charge level is sufficient to increase the distance from the rear vehicle, the apparatus for controlling water emission of a vehicle accelerates in the EV mode (only EV mode) and informs using the HMI that the distance from the rear vehicle is increased by accelerating in the EV mode in operation S206.

If the battery charge level is insufficient to increase the distance from the rear vehicle, the apparatus for controlling water emission of a vehicle determines whether there is a possibility of contaminating the rear vehicle if changing lanes in operation S207.

If there is a possibility of contaminating the rear vehicle when changing lanes, the apparatus for controlling water emission of a vehicle changes lanes and informs that, “Change lanes to emit water. Do not get too close.” using the HMI in operation S208

If there is no possibility of contamination of the rear vehicle when changing lanes, the apparatus for controlling water emission of a vehicle limits acceleration and informs that “the vehicle is driving at a constant speed due to concerns about rear vehicle contamination when water is emitted.” in operation S209.

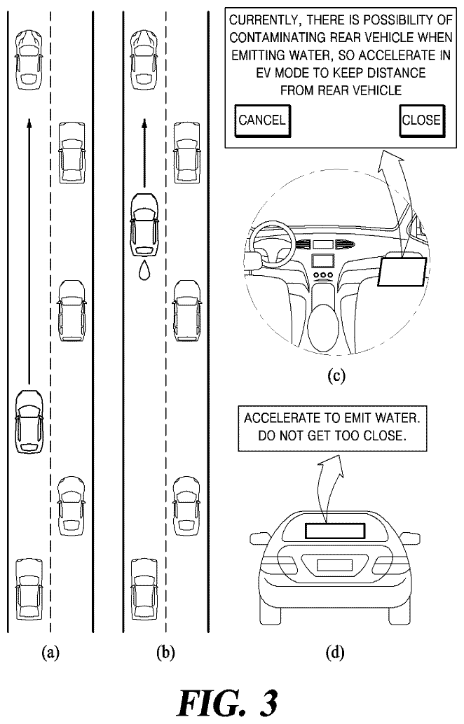

FIGS. 3-7 are various diagrams illustrating a method for controlling water emission of a vehicle according to an embodiment of the present disclosure.

A scenario for determining the possibility of water emission for reducing rear vehicle contamination according to an embodiment of the present disclosure is as shown in Table 1 and FIGS. 3-7 but is not limited to a specific form.

TABLE 1

| | Scenario | | Passenger | e-HMI for rear |
|---|---|---|---|---|
| Scenario | Classification | Control | HMI | vehicle |
| 1 | When it is | Water emission | Currently, | Accelerate to |
| | possible to | after acceleration | there is | emit water. Do |
| | increase distance | in EV mode to | possibility of | not get too close. |
| | from rear vehicle | suppress water | contaminating | |
| | | generation | rear vehicle | |
| | | | when emitting | |
| | | | water, so | |
| | | | accelerate in | |
| | | | EV mode to | |
| | | | keep distance | |
| | | | from rear | |
| | | | vehicle | |
| 2 | When it is | Emit water after | Currently, | Change lanes to |
| | possible to avoid | changing lanes | there is | emit water. Do |
| | rear vehicle by | | possibility of | not get too close. |
| | changing lanes | | contaminating | |
| | | | rear vehicle | |
| | | | when emitting | |
| | | | water, so | |
| | | | change lanes. | |
| 3 | When EV charge | Acceleration | Acceleration is | Drive at constant |
| | level is low and it | limits and water | limited | speed due to |
| | is not possible to | emission delays | because there | concerns about |
| | change lanes | | is possibility | contamination of |
| | | | of | rear vehicle when |
| | | | contaminating | emitting water |
| | | | rear vehicle | |
| | | | when water is | |
| | | | emitted due to | |
| | | | acceleration. | |
| 4 | When it is | Minimum | Emission of | [Rear Display] |
| | necessary to emit | emissions and | water is | Water is emitted. |
| | water even though | rear vehicle | inevitable, so | Please maintain |
| | there is possibility | guidance | possibility of | appropriate |
| | of rear vehicle | | rear vehicle | distance. |
| | contamination. | | contamination | [Road |
| | | | is informed | projection] |
| | | | and water is | |
| | | | emitted. | |
| 5 | When there is no | Regular amount | Water is | — |
| | possibility of | of water emission | emitted (no | |
| | contaminating | | possibility of | |
| | rear vehicle | | rear vehicle | |
| | | | contamination). | |

Through scenarios 1-5 in Table 1, an embodiment of the present disclosure may reduce contamination damage to a rear vehicle due to water emission by providing HMI to nearby vehicles.

Referring to Table 1, in scenario 1, as shown in (a) of FIG. 3, when it is possible to increase the distance from the rear vehicle, the apparatus for controlling water emission of a vehicle controls the emission of water after acceleration in EV mode to suppress water generation as shown in (b) of FIG. 3.

At the same time, as shown in (c) of FIG. 3, the apparatus for controlling water emission of a vehicle informs that, for example, “There is a possibility of contaminating rear vehicle when emitting water, so accelerate in the EV mode to keep a distance from the rear vehicle.” using a passenger HMI.

Also, as shown in (d) of FIG. 3, the apparatus for controlling water emission of a vehicle informs that, for example, “Accelerate to emit water. Do not get too close.” using an e-HMI for the rear vehicle.

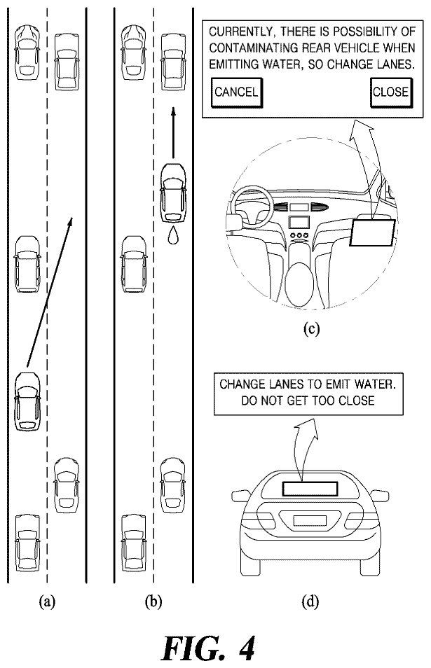

Referring to Table 1, in scenario 2, as shown in (a) of FIG. 4, when it is possible to avoid the rear vehicle by changing lanes, the apparatus for controlling water emission of a vehicle controls to emit water after changing lanes as shown in (b) of FIG. 4.

At the same time, as shown in (c) of FIG. 4, the apparatus for controlling water emission of a vehicle informs that, for example, “Change lanes because there is a possibility of contaminating the rear vehicle when water is emitted.” using the passenger HMI.

Also, as shown in (d) of FIG. 4, the apparatus for controlling water emission of a vehicle informs that, for example, “Change lanes to emit water. Do not get too close.” using the e-HMI for the rear vehicle.

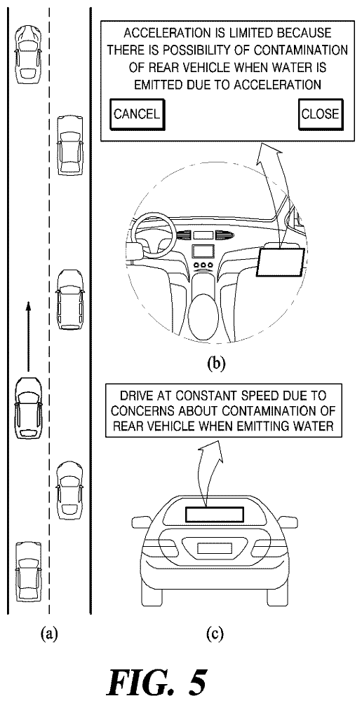

Referring to Table 1, in scenario 3, as shown in (a) of FIG. 5, when the EV charge level is insufficient and it is not possible to change lanes, the apparatus for controlling water emission of a vehicle controls to limit acceleration and delay water emission.

At the same time, as shown in (b) of FIG. 5, the apparatus for controlling water emission of a vehicle informs that, for example, “There is a possibility of contamination of the rear vehicle when water is emitted due to acceleration, so acceleration is limited.” using the passenger HMI.

Also, as shown in (c) of FIG. 5, the apparatus for controlling water emission of a vehicle informs that, for example, “the vehicle is driving at a constant speed due to concerns about contamination of the rear vehicle when water is emitted.” using the e-HMI for the rear vehicle.

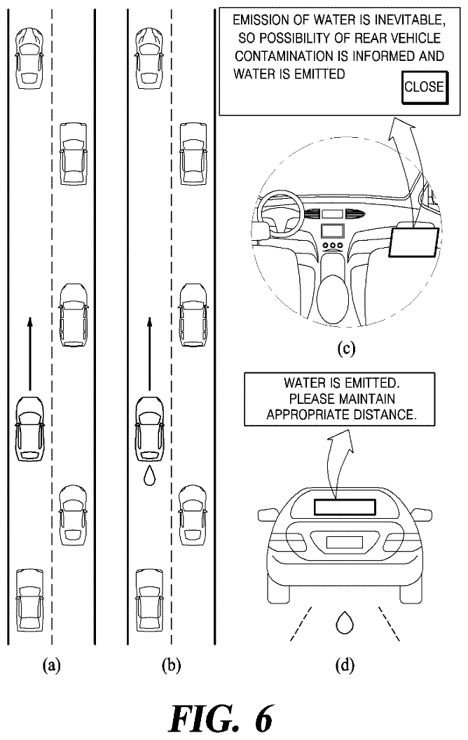

Referring to Table 1, in scenario 4, as shown in (a) of FIG. 6, when it is necessary to emit despite the possibility of rear vehicle contamination, the apparatus for controlling water emission of a vehicle controls to emit a minimum amount and guide the rear vehicle, as shown in (b) of FIG. 6.

At the same time, as shown in (c) of FIG. 6, the apparatus for controlling water emission of a vehicle informs that, for example, “Water emission is inevitable, so inform about the possibility of contamination of the rear vehicle and emit the water.” using the passenger HMI. The passenger HMI is a display provided inside the vehicle but is not limited to a specific type.

Also, as shown in (d) of FIG. 6, the apparatus for controlling water emission of a vehicle informs that, for example, “Water is being emitted. Please maintain an appropriate distance.” using the e-HMI for the rear vehicle.

The e-HMI for the rear vehicles is a display provided outside the rear of the vehicle but is not limited to a specific form.

The apparatus for controlling water emission of a vehicle may display a shape of water emission on the road surface using a road surface projection, as shown in (d) of FIG. 6.

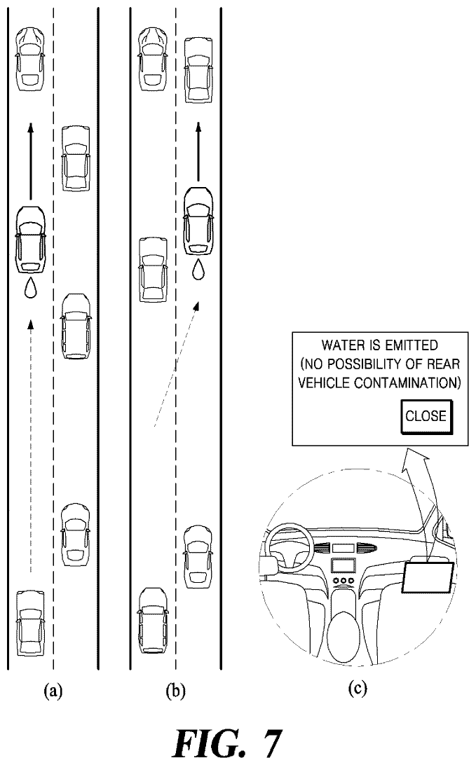

Referring to Table 1, in scenario 5, as shown in (a) of FIG. 7, when there is no possibility of rear vehicle contamination, the apparatus for controlling water emission of a vehicle controls to emit a regular amount of water, as shown in (b) of FIG. 7.

At the same time, the apparatus for controlling water emission of a vehicle informs that, for example, “Water is emitted. (There is no possibility of rear vehicle contamination)” using the passenger HMI as shown in (c) of FIG. 7.

Also, since the apparatus for controlling water emission of a vehicle does not need to guide using the e-HMI for the rear vehicle because there is no possibility of contamination of the rear vehicle.

As shown in FIG. 3 to (c) of FIG. 7, the passenger HMI is a display provided in the vehicle and displays information related to vehicle control to prevent contamination of rear vehicles.

As shown in FIG. 3 through (d) of FIG. 6, the e-HMI for the rear vehicle is a display provided at the back of the vehicle and displays guidance for nearby vehicles to prevent contamination of rear vehicles.

In the drawings of the present specification, it is described that the processes are sequentially executed, but this is merely an example of an embodiment of the present disclosure. In other words, those having ordinary skill in the art to which an embodiment of the present disclosure pertains may change and execute the order described in the drawings or may perform one of processes in parallel to apply various modifications and variations without departing from the scope of the present disclosure. Therefore, the drawings are not limited to a time-series sequence.

The processes (i.e., the steps) shown in FIG. 2 may be implemented as computer-readable codes on a computer-readable recording medium. The computer-readable recording medium includes all types of recording devices in which data readable by a computer system is stored. The computer-readable recording medium may be non-transitory mediums, such as ROM, RAM, CD-ROM, magnetic tape, floppy disk, optical data storage device, and the like. In addition, the computer-readable recording medium may be distributed in a network-connected computer system, and a computer-readable code may be stored and executed in a distributed manner.

Further, components of some embodiments of the present disclosure may utilize integrated circuit structures such as memories, processors, logic circuits, look-up tables, and the like. These integrated circuit structures may perform each of the functions described herein under the control of one or more microprocessors or other control devices. Further, components of some embodiments of the present disclosure may be specifically implemented by a portion of a program or code that includes one or more executable instructions for performing a particular logical function and may be executed by one or more microprocessors or other control devices. Components of some embodiments of the present disclosure may include or be implemented by a central processing unit (CPU), microprocessor, or the like that performs their respective functions. Components of some embodiments of the present disclosure may store instructions executed by one or more processors in one or more memories.

Although example embodiments of the present disclosure have been described for illustrative purposes, those having ordinary skill in the art should appreciate that various modifications, additions, and substitutions are possible, without departing from the idea and scope of the present disclosure. Therefore, example embodiments of the present disclosure have been described for the sake of brevity and clarity. The scope of the technical ideas of embodiments of the present disclosure is not necessarily limited by the illustrations. Accordingly, one of ordinary skill would understand the scope of the present disclosure is not to be limited by the above explicitly described embodiments but by the claims and equivalents thereof.

What is claimed is:

1. An apparatus for controlling water emission of a vehicle, the apparatus comprising:
a water amount determination part configured to determine an amount of water held in the vehicle through a sensor;
a surrounding situation recognition part configured to recognize nearby vehicles including a trailing vehicle driving within a predetermined distance behind the vehicle; and
a vehicle controller configured to control at least one of an emission time or an emission amount of the water depending on the amount of water and a presence or absence of the nearby vehicles.

2. The apparatus of claim 1, further comprising:
a display configured to display a guidance related to emission of the water and a guidance related to control of the vehicle.

3. The apparatus of claim 1, wherein the vehicle controller, when the amount of water is equal to or greater than a predetermined amount and the rear vehicle exists, increases a distance from the trailing vehicle using an acceleration mode and then controls to emit the water.

4. The apparatus of claim 3, further comprising:
a display configured to display, inside the vehicle, that the vehicle accelerates in the acceleration mode and maintains a certain distance from the trailing vehicle, and configured to display, outside the vehicle, that the vehicle accelerates to emit the water.

5. The apparatus of claim 3, wherein the vehicle controller controls to limit emission of the water when it is impossible to increase the distance from the rear vehicle.

6. The apparatus of claim 1, wherein, when the amount of water is equal to or greater than a predetermined amount and there are no other vehicles in a left lane to the left or a right lane to the right of the vehicle, the vehicle controller controls to emit the water after changing lanes to the left or right lane.

7. The apparatus of claim 6, further comprising:
a display configured to display, inside and outside the vehicle, that a lane change is to prevent water emission to the trailing vehicle.

8. The apparatus of claim 1, wherein the water amount determination part includes:
a water storage amount recognition module configured to recognize a storage amount of the water; and
a water expected amount prediction module configured to predict an expected amount of water that is additionally generated according to the driving of the vehicle.

9. The apparatus of claim 1, wherein, when an electric charge level of the vehicle is less than a predetermined threshold and it is not possible to change lanes, the vehicle controller controls to limit acceleration of the vehicle and delay emission of the water.

10. The apparatus of claim 9, further comprising:
a display configured to display, inside the vehicle, that acceleration is limited to prevent emission of the water due to acceleration, and configured to display, outside the vehicle, that the vehicle drives at a constant speed to prevent emission of the water.

11. The apparatus of claim 1, wherein, when there is a possibility of splashing the water to the trailing vehicle and it is necessary to emit water immediately, the vehicle controller controls to emit a minimum amount of water.

12. The apparatus of claim 11, further comprising:
a display configured to display, inside of the vehicle, that the water is emitted to the trailing vehicle and configured to display, outside the vehicle, that an appropriate distance is to be maintained because the water is emitted.

13. The apparatus of claim 1, wherein, when there is no possibility of splashing the water to the trailing vehicle, the vehicle controller controls to immediately emit a regular emission amount of the water.

14. The apparatus of claim 13, further comprising:
a display configured to display, inside the vehicle, that the regular emission amount of the water is emitted.

15. A method for controlling water emission of a vehicle, the method comprising:
determining, by a sensor of a water amount determination part, an amount of water held in the vehicle;
recognizing, by a surrounding situation recognition part, nearby vehicles including a trailing vehicle driving within a predetermined distance behind the vehicle; and
controlling, by a vehicle controller, at least one of an emission time or an emission amount of the water, depending on the amount of water and a presence or absence of the nearby vehicles.

16. The method of claim 15, further comprising:
displaying a guidance related to emission of the water and a guidance related to control of the vehicle.

17. The method of claim 15, wherein, in the controlling step, when the amount of water is equal to or greater than a predetermined amount and the trailing vehicle is present, a distance from the rear vehicle is increased using an acceleration mode and then the water is controlled to be emitted.

18. The method of claim 17, further comprising:
displaying, inside the vehicle, that the vehicle accelerates in the acceleration mode and maintains a certain distance from the trailing vehicle; and
displaying, outside the vehicle, that the vehicle accelerates to emit the water.

19. The method of claim 17, wherein, in the controlling step, emission of the water is controlled to be limited when it is impossible to increase the distance from the trailing vehicle.

20. The method of claim 15, wherein, in the controlling step, when the amount of water is equal to or greater than a predetermined amount and there are no other vehicles in a left lane to the left or a right lane to the right of the vehicle, the water is controlled to be emitted after changing lanes to the left or right lane.
